(19) United States
(12) Patent Application Publication
(10) Pub. No.: US 2010/0023984 A1
(43) Pub. Date: Jan. 28, 2010

(54) Identifying Events in Addressable Video Stream for Generation of Summary Video Stream

(76) Inventors: John Christopher DAVI, Palo Alto, CA (US); Glenn Thomas Millican, III, Mountain View, CA (US)

Correspondence Address: LEON R TURKEVICH, 2000 M STREET NW, 7TH FLOOR, WASHINGTON, DC, 200363307, US

(21) Appl. No.: 12/181,136

(22) Filed: Jul. 28, 2008

(51) Int. Cl. H04N 7/173

(52) U.S. Cl. 725/110

(57) ABSTRACT

In one embodiment, a method comprises identifying, by a device, an addressable media stream selected for presentation by a user; identifying, by the device, a user input that is input by the user during presentation of the addressable media stream to the user, the user input identified relative to an identified position within the addressable media stream; defining by the device a media clip from the addressable media stream based on determining the user input demonstrates a favorable affinity by the user toward the identified position, the defining including the device selecting a media clip start position within the addressable media stream and that precedes the identified position, and the device selecting a media clip end position that follows the identified position; and creating by the device a summary media clip of the addressable media stream that includes at least the media clip.

### TECHNICAL FIELD

The present disclosure generally relates to creation of a summary video stream from a source addressable video stream.

### BACKGROUND

A summary video stream is a shortened version of a source addressable video stream, where selected portions (i.e., video “clips”) of the source addressable video stream are concatenated together to form the summary video stream. An example of a summary video stream is a two or three minute trailer or preview of a full length movie having an example duration of two hours. A summary video clip typically has been created based on a user of a computer-based video editing system manually selecting video clips to be assembled into the summary video stream: each video clip can be manually identified by the user specifying a corresponding start position and a corresponding end position for the video clip relative to the source addressable video stream. Each video clip also can be predefined, for example based on detection of scene transitions: in this example, the user manually selects each predefined video clip to be added to the summary video stream (or modifies the start position and corresponding end position of one of the predefined video clips), and sends a request to the computer-based video editing system to compile (or “render”) the selected video clips into the summary video stream.

### BRIEF DESCRIPTION OF THE DRAWINGS

Reference is made to the attached drawings, wherein elements having the same reference numeral designations represent like elements throughout and wherein:

FIGS. 1A and 1B illustrate an apparatus configured for creating a summary media clip based on defining at least one media clip from a user input determined as demonstrating a favorable affinity toward an identified position of an addressable media stream, according to an example embodiment.

FIG. 2 illustrates another apparatus configured for creating a summary media clip based on defining at least one media clip from a user input determined as demonstrating a favorable affinity toward an identified position of an addressable media stream, according to another example embodiment.

FIG. 3 illustrates determining a distribution of user inputs demonstrating a favorable affinity toward identified positions within an addressable video stream, for generating one or more media clips for a summary media clip of the addressable media stream, according to an example embodiment.

FIGS. 4A and 4B summarize an example method for creating a summary media clip, according to an example embodiment.

### DESCRIPTION OF EXAMPLE EMBODIMENTS

### Overview

In one embodiment, a method comprises identifying, by a device, an addressable media stream selected for presentation by a user; identifying, by the device, a user input that is input by the user during presentation of the addressable media stream to the user, the user input identified relative to an identified position within the addressable media stream; defining by the device a media clip from the addressable media stream based on determining the user input demonstrates a favorable affinity by the user toward the identified position, the defining including the device selecting a media clip start position within the addressable media stream and that precedes the identified position, and the device selecting a media clip end position that follows the identified position; and creating by the device a summary media clip of the addressable media stream that includes at least the media clip.

In another embodiment, an apparatus comprises a device interface circuit and a processor circuit. The device interface circuit is configured for detecting selection of an addressable media stream selected for presentation by a user. The device interface circuit further is configured for detection of a user input that is input by the user. The processor circuit is configured for identifying the addressable media stream selected for presentation by the user. The processor circuit also is configured for identifying that the user input is input by the user during presentation of the addressable media stream to the user, the user input identified relative to an identified position within the addressable media stream. The processor circuit is configured for defining a media clip from the addressable media stream based on determining the user input demonstrates a favorable affinity by the user toward the identified position, the defining including selecting a media clip start position within the addressable media stream and that precedes the identified position, and selecting a media clip end position that follows the identified position. The processor circuit is configured for creating a summary media clip of the addressable media stream that includes at least the media clip.

### DETAILED DESCRIPTION

Particular embodiments disclosed herein enable a user input to be associated with an identifiable position within an identifiable addressable media stream, in order to automatically define a media clip that can be used in creating a summary media clip of the addressable media stream. The term “addressable” as used herein with respect to media streams refers to a media stream having positional attributes, for example a time index or time code, that enables identification of one or more events within the media stream relative to a corresponding position within the media stream. Hence, an addressable media stream can present a sequence of events that is deterministic and repeatable. An example of a media stream that is not an addressable media stream is a live broadcast which cannot be consumed at a later date.

The association of the user input with the identified position within the identifiable addressable media stream establishes a relationship between an event presented in the addressable media stream and the user's reaction (expressed by the user input) to the event presented in the addressable media stream, where the event is identifiable by the position within the addressable media stream.

The user input also can be used to determine whether the user's reaction demonstrates a favorable affinity by the user toward the event presented at the corresponding identified position in the addressable media stream. In particular, the particular embodiments enable identification of a user's affinity or opinion toward an event within the addressable media stream, without the necessity of identifying or interpreting the actual event presented within the addressable media stream. In other words, the act of a user supplying a user input at a specific instance in response to experiencing an event presented by the addressable media stream can demonstrate a substantially strong opinion or preference by the user with respect to the event that has just been consumed (e.g., viewed or heard) by the user at that particular position of the addressable media stream.

For example, assume a user is viewing a network content asset in the form of a sports event, a movie, a televised political debate, or an episode of a dramatic television series via an addressable media stream. The addressable media stream can be downloaded from a network in the form of streaming media, or retrieved from a local storage medium such as a DVD. The user can have such a strong emotional reaction to a specific event presented in the addressable media stream that the user can supply a user input, for example turning up a volume control, maximizing a display of a media player on a computer, pressing a prescribed key on a user device (e.g., a “thumbs-up” or “smiley face”), or submitting a user comment via the network to a destination. The comment can be input by the user in the form of an instant message, a short message to a cell phone, a message posting to an online bulletin board, etc. Such an emotional reaction by the user to the specific event in the addressable media stream can be recorded based on identifying not only the user input, but also the “position” (e.g., time code) of the addressable media stream that identifies the event that is supplied to the user at the instant the user comment is detected.

Hence, the emotional reaction by the user to the specific event in the addressable media stream can be recorded based on detecting the instance the user supplies the user input, coincident with the position of the addressable media stream that is being supplied for presentation to the user. An affinity by the user toward the event at the instance the user supplied the user input can be determined based on interpreting the user input.

Hence, if the user input demonstrates a favorable affinity by the user toward the identified position that presented an event, the user input can be used for creation of a summary media clip of the addressable media stream that includes the event presented at the identified position. Further, the event presented at the identified position can be captured based on selecting media clip start and stop positions that precede and follow the identified position, respectively (e.g., based on a prescribed number of seconds, or detected scene transitions, or based on dynamically determined factors). Multiple user inputs demonstrating a favorable affinity by the user toward respective identified positions also can be used to create a summary media clip that includes multiple media clips containing respective “favorite events” that were presented at the respective identified positions, where each “favorite event” is defined by a media clip that contains the event at the identified position, and a corresponding start position and end position.

Consequently, a summary media clip of the addressable media stream can be created solely based on identifying one or more user inputs that are input by the user during presentation of the addressable media stream, where the one or more user inputs demonstrate a favorable affinity toward the identified position. Moreover, a summary media clip created based on identifying a position having a favorable affinity (as demonstrated by the corresponding input) enables the summary media clip to be generated without the necessity of actually determining the actual content of the event that cause the user to supply the user input.

Multiple messages from distinct users also can be collected by one or more prescribed destinations. Hence, multiple messages from distinct users having been presented the addressable media stream (either simultaneously or at distinct presentation instances) can be aggregated in order to identify the “favorite events” among multiple users, enabling the automatic generation of a summary media clip of the addressable media stream based on determining a distribution of the most “favorite events” among the user inputs. In addition, different summary clips can be created for different classes of users based on defining different groups or classes of users (e.g., men, women, children), also referred to as “cohorts”.

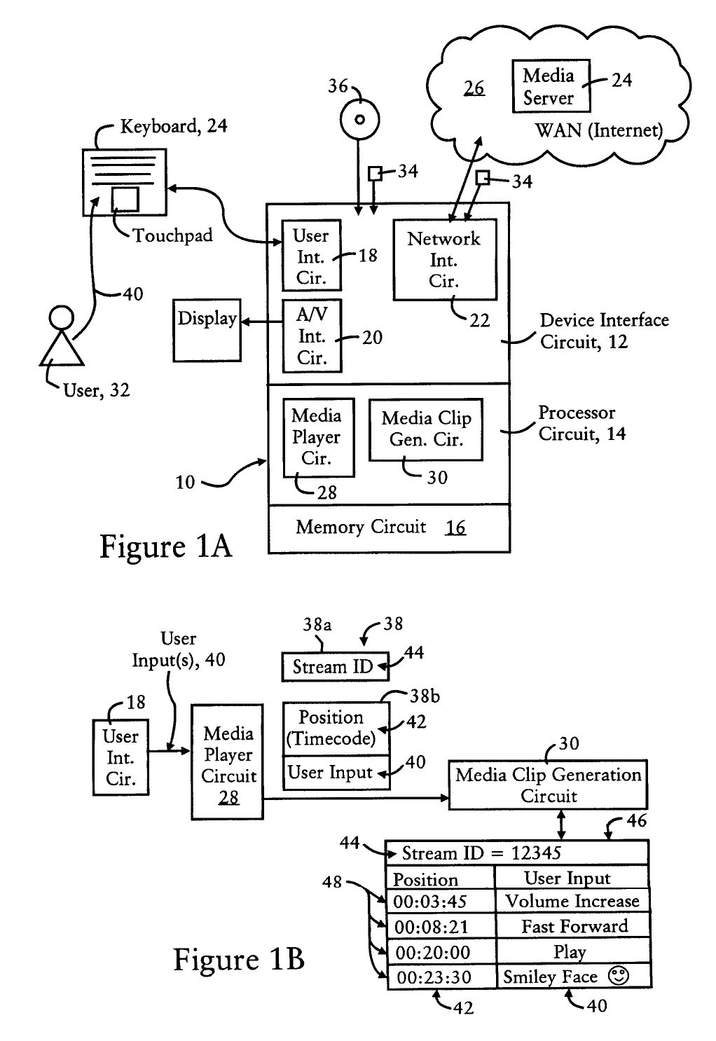

FIG. 1A illustrates an example apparatus configured for generating a summary media clip of an addressable media stream, according to an example embodiment. The apparatus 10 includes a device interface circuit 12, a processor circuit 14, and a memory circuit 16.

The device interface circuit 12 includes a user interface circuit 18, an audio/video display interface circuit 20, and a network interface circuit 22. The user interface circuit 18 can be configured for receiving user inputs from a user interface device 24, implemented for example as a computer keyboard that can include a pointing device such as a touchpad or mouse, etc. The user interface circuit 18 also can have input keys that enable a user 32 to supply (i.e., enter) user inputs directly to the apparatus 10 without the necessity of the user interface device 24. Alternately, the user interface device 24 can be implemented within the apparatus 10, for example in the form of a computer laptop. The keyboard 24 can include context-based function keys that can be assigned a prescribed function, described below.

The audio/video display interface circuit 20 can be configured for generating audio and/or video signals for presentation to a user, for example in the form of a display such as a laptop display; the audio/video display interface circuit 20 also can output the audio and/or video signals to an external display.

The network interface circuit 22 can be configured for Internet Protocol (IP)-based communications with a remote server (e.g., a media server) 24 via an IP-based local area network (LAN) or a wide area network (WAN) 26, for example the Internet. The network interface circuit 22 can be implemented, for example, as a wired or wireless ethernet (IEEE 802) transceiver.

The processor circuit 14 can include a media player circuit 28 and a media clip generation circuit 30. The media player circuit 28 can be configured for presenting an addressable media stream 34 for display via the audio/video display interface circuit 20 to a user 32: the addressable media stream can be received by the device interface circuit 12, for example from a local tangible storage medium such as a DVD ROM 36, or from the media server 24 via an IP-based connection via the wide area network 26. The addressable media stream 34 can be any one of an audio stream (e.g., MP3), a video stream, or any combination thereof. Hence, the media player circuit 28 can present the addressable media stream 34 to the user 32 in response to control inputs supplied by the user either via the user input device 24 or via input keys (or touchpad) implemented on the user interface circuit 18.

The user inputs, received by the user interface circuit 18, are forwarded to the media player circuit 28 for execution. The media player circuit 28 can respond to the user inputs, for example, by increasing a volume of the audio or video media stream 34, causing, fast forwarding, rewinding, etc.

FIG. 1B illustrates in further detail interactions between the media player circuit 28 and the media clip generation circuit 30. According to example embodiments, the media player circuit 28 can forward one or more messages 38 to the media clip generation circuit 30 that enables the media clip generation circuit 30 to associate the user input 40 detected by the media player circuit 28 with an identifiable position 42 within the identified addressable media stream 34. As illustrated in FIG. 1B, the media player circuit 28 can send to the media clip generation circuit 30 a first message 38a that specifies a media stream identifier 44 that uniquely identifies the addressable media stream 34. Hence, the media stream identifier 44 within the first message 38a enables the media clip generation circuit 32 identify the addressable media stream 34 that is selected for presentation by the user 32.

In response to receiving the first message 38a that specifies the media stream identifier 44, the media clip generation circuit 30 can create and store within the memory circuit 16 a new data structure 46, also referred to as a user response data file 46, configured for storing user input entries 48 that identify user inputs 40 that are input by the user 32 at the respective positions 42 within the addressable media stream 34. The data structure 46 also can be stored within an external computer-readable storage medium reachable by the processor circuit 14. The media player circuit 28 can output a message 38b, specifying a user input 40 and the corresponding position 42 within the addressable media stream 34 that coincides with the time instance that the user 32 entered the corresponding user input 40, for each corresponding input by the user 32. Alternately, the media player circuit 28 can output a message 38b that specifies a plurality of user inputs 40 supplied by the user 32 at the respective specified positions 42.

Hence, the media clip generation circuit 30 can identify, from the received messages 38 (e.g., 38a and 38b), that a user input 40 is input by the user 32 during presentation of the addressable media stream 34 to the user 32, where each user input 40 is identified relative to a corresponding identified position 42 within the addressable media stream 34 and that coincides with the time instance that the user supplied the corresponding input 40. The media clip generation circuit 30 can store the user input 40 and corresponding identified position 42 specified in each received message 38b into the data structure 46 as the user 32 is consuming (e.g., viewing or listening to) the identified addressable media stream 34.

The media player circuit 28 and the media clip generation circuit 30 of FIGS. 1A and 1B can be implemented within the same processor circuit 14, enabling the message 38a and/or 38b to be implemented in the form of a shared memory location of a data structure in the memory circuit 16, for example in the case of the media player circuit 28 and the media clip generation circuit 30 communicating via an application programming interface (API) or a dynamically linked library (DLL).

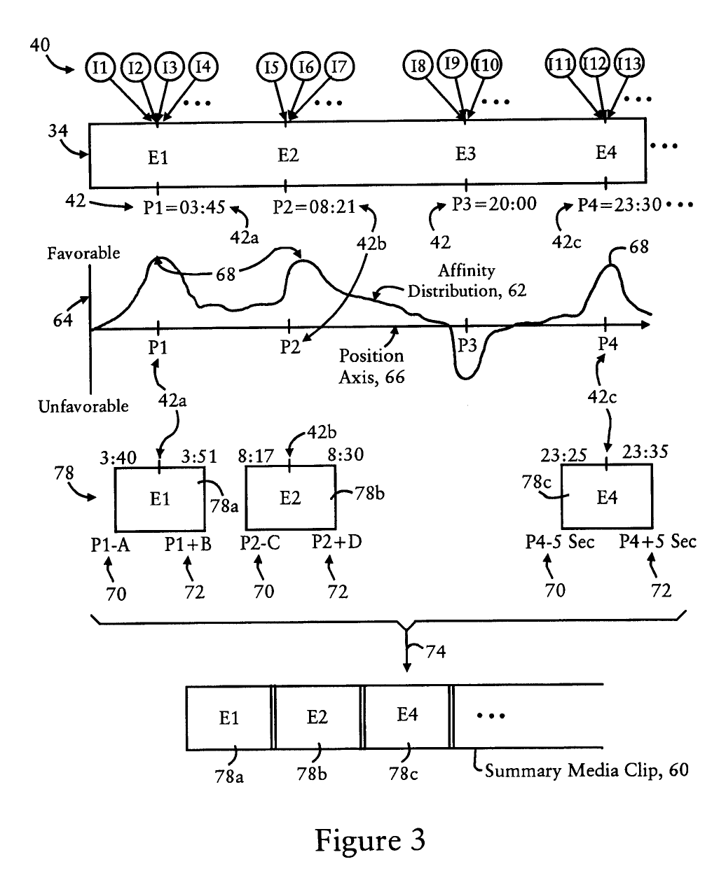

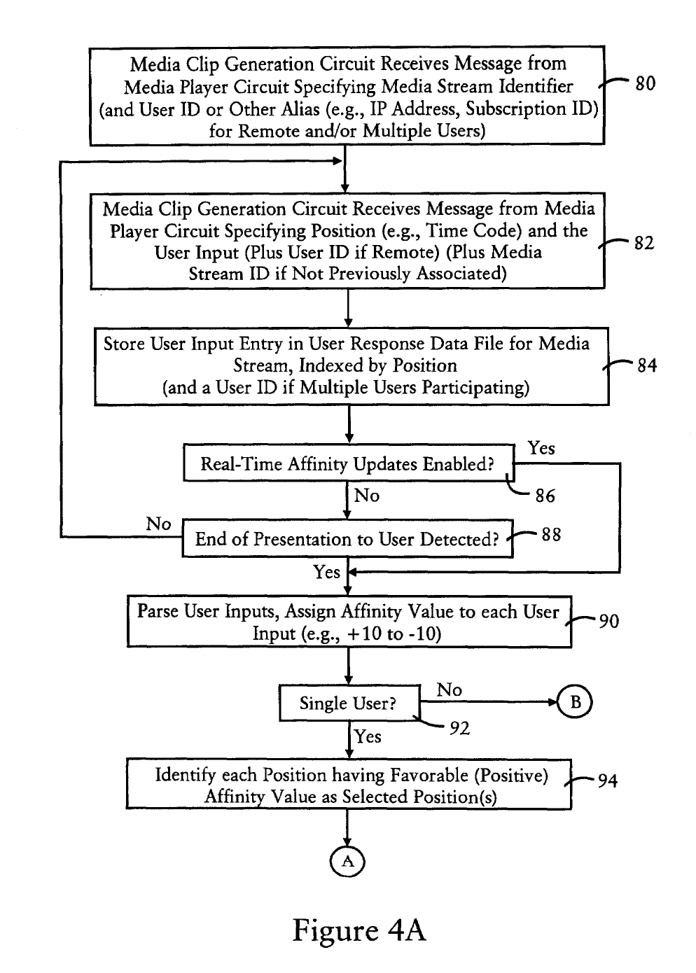

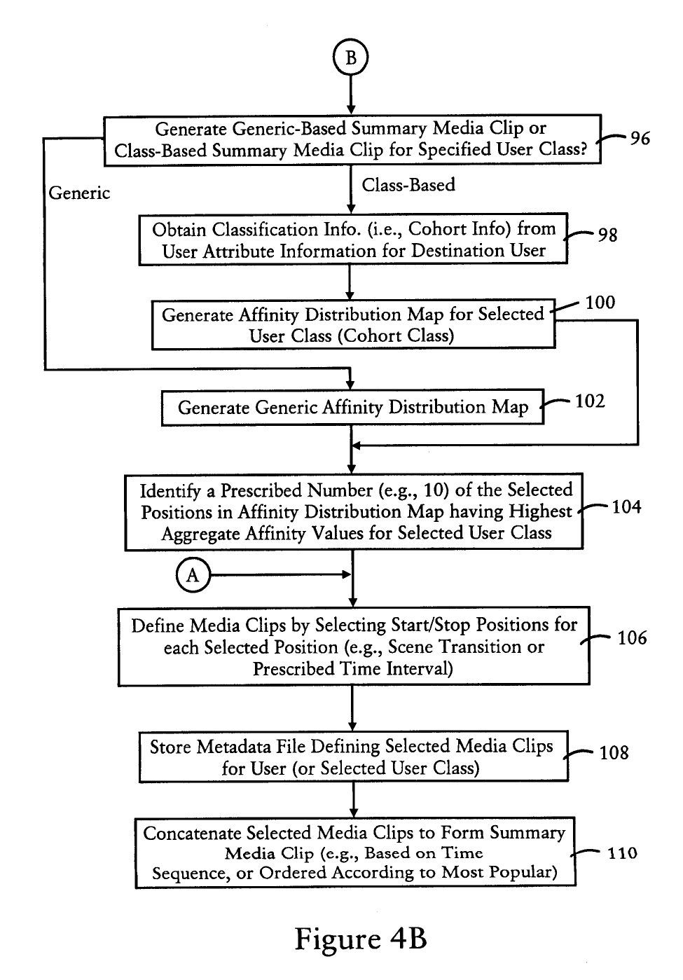

As described below with respect to FIGS. 3 and 4, the media clip generation circuit 30 can identify the user inputs 40 that demonstrate a favorable affinity by the user 32 toward the respective associated positions 42 within the addressable media stream 34. The media clip generation circuit can identify the user inputs 40 demonstrating a favorable affinity toward the respective positions 42 as the messages 38b are received, or based on retrieving the user inputs 40 stored in the data structure 46. Consequently, the media clip generation circuit 30 can define a media clip for an identified position 42 determined as having a favorable affinity by the user 32: a media clip can be defined for at least one identified position 42 determined as having a favorable affinity; alternately, a media clip can defined for each corresponding identified position 42 determined as having a favorable affinity; as another example, selected positions 42 may be identified for defining one or more media clips based on a determined distribution of affinity values. A summary media clip can thus be generated by the media clip generation circuit 30, wherein the summary media clip includes at least one media clip containing at least one identified position having a favorable affinity by the user 32. The summary media clip generated by the media clip generation circuit 30 also can include multiple media clips concatenated according to a prescribed sequence, for example based on position within the addressable media stream or ordered based on highest aggregate affinity values.

The apparatus 10 of FIG. 1A can be implemented for example as a personal computer, a laptop computer, or a set top box coupled to a television and cable service provider. Hence, the network interface circuit 22 also can be implemented as a cable modem or another wired or wireless interface configured for sending and receiving data with a service provider.

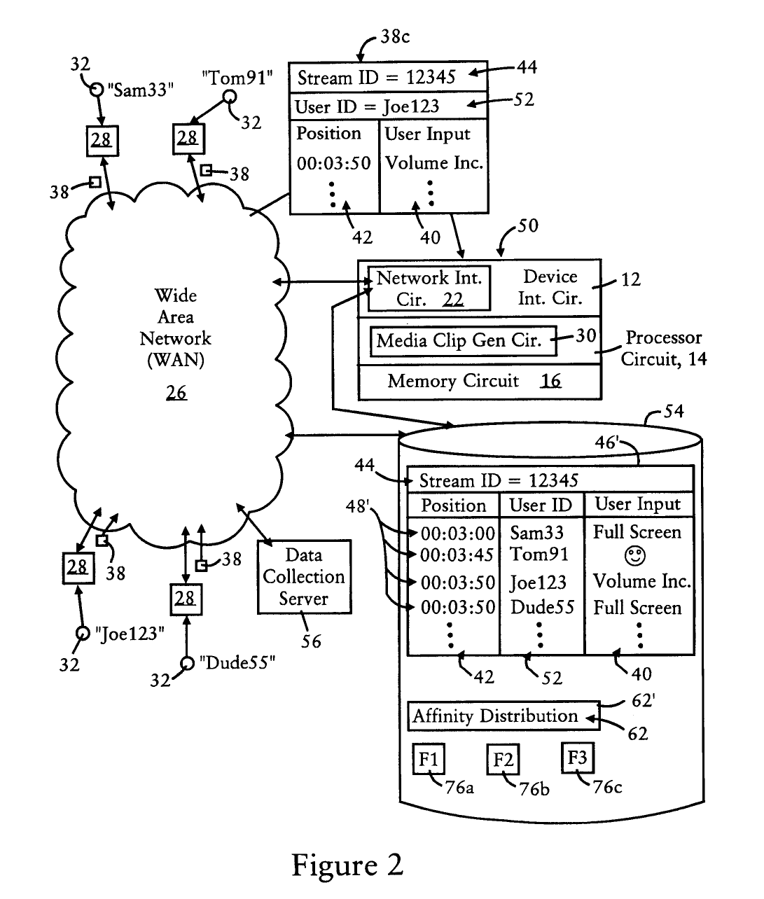

FIG. 2 illustrates another example apparatus 50 containing the media clip generation circuit 30 configured for creating a summary media clip of an addressable media stream 34, according to an example embodiment. The apparatus 50 of FIG. 2 can be implemented for example as a web server reachable via the wide area network 26 and configured for receiving messages 38 (e.g., 38c) from a media player circuit 28 executed by a user 32 at a customer premises. As illustrated in FIG. 2, the server 50 includes a device interface circuit 12 including at least a network interface circuit 22, a processor circuit 14, and a memory circuit 16. The network interface circuit 22 of the server 50 can be configured for receiving, via the wide area network 26, messages 38 from multiple media player circuits 28 controlled by respective users 32.

As illustrated in FIG. 2, each message 38 that is transmitted from a media player circuit 28 to the server 50 via a wide area network 26 can include a media stream identifier 44, a user identifier 52 for uniquely identifying the user 32, at least one of the user inputs 40 input by the user 32 during presentation of the corresponding addressable media stream 34, and at least one corresponding identified position 42 that identifies the instance within the addressable media stream 34 that the user 32 input the corresponding input 40. The processor circuit 14 of FIG. 2 also includes the media clip generation circuit 30. Hence, in response to receiving a message 38 (e.g., 38c) from one or more users 32 via the wide area network 26, the media clip generation circuit 30 within the processor circuit 14 of the server 50 can add a corresponding user input entry 48′ to a data structure 46′ that specifies the user input 40, the corresponding identified position 42, and the corresponding user identifier 52. As illustrated in FIG. 2, the data structure 46′ can be stored in a database 54: the database 54 can be local to the server 50, or reachable via either a local area network or the wide area network 26. The addition of user input entries 48′ to the data structure 46′ also can be distributed among multiple servers, such as distributed data collection servers 56, enabling user inputs 40 from multiple users 32 to be aggregated based on storage within the data structure 46′. The media clip generation circuit 30 also can update a data structure 62′ in response to each received message 38, where the data structure 62′ describes an aggregated affinity distribution 62, illustrated in FIG. 3, relative to the positions within the addressable media stream. The media clip generation circuit 30 in the server 50 and/or the data collection server can index the entries 48′ in the database 46′ according to the identified positions 42, the respective user inputs 40, and/or the user identifiers 52.

As described below, the user identifiers 52 do not need to include personally identifiable information, but can simply include one or more attributes that enable a given user 32 to be distinguished from another user 32, for example based on IP address, user alias, a randomly assigned identifier, the IP address utilized by the user device executing the media player circuit 28, etc.

Further, each user identifier 52 can be associated with distinct user attributes that enable each user to be classified in different classes, or “cohorts” (e.g., men, women, members, guests, age-based classification, demographic-based classification, etc.), enabling different user classes to be established for different user preferences. An example of user classification is described in further detail in commonly-assigned, copending U.S. patent application Ser. No. 12/110,224, filed Apr. 25, 2008, entitled “Identifying User Relationships from Situational Analysis of User Comments Made on Media Content”. In summary, the processor circuit 14 can detect a first comment that is input by a first user at an instance coincident with the first user having been supplied a first identified position of a content asset such as the addressable video stream 34; the processor circuit 14 also can detect a second comment that is input by a second user at an instance coincident with the second user having been supplied a second identified position of the content asset. The processor circuit 14 can selectively establish a similarity relationship between the first and second users, based on a determined positional similarity between the first and second comments based on the respective first and second identified positions relative to the content asset, and a determined content similarity between the first and second comments.

Any of the disclosed circuits of the apparatus 10 or 50 (including the device interface circuit 12, the processor circuit 14, the memory circuit 16, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown), where execution of executable code stored in an internal memory circuit (e.g., within the memory circuit 16) causes the processor circuit to store application state variables in processor memory, creating an executable application resource (e.g., an application instance) that performs the operations of the circuit as described herein. Hence, use of the term “circuit” in this specification refers to both a hardware-based circuit that includes logic for performing the described operations, or a software-based circuit that includes a reserved portion of processor memory for storage of application state data and application variables that are modified by execution of the executable code by a processor circuit. The memory circuit 16 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a tangible memory medium in the disclosed apparatus (e.g., in a receive buffer). Also note that the memory circuit 16 can be implemented dynamically by the processor circuit 14, for example based on memory address assignment and partitioning executed by the processor circuit 14.

FIG. 3 illustrates an example summary media clip 60 that can be created by the media clip generation circuit 30 of FIGS. 1A and 1B or FIG. 2, according to an example embodiment. The media clip generation circuit 30 is configured for creating a summary media clip 60 from the addressable media stream 34 based on identifying one or more user inputs 40 by or more users 32 at identified positions 42 within the addressable media stream 34.

The media clip generation circuit 30 illustrated in FIG. 2 can identify a user input, identified relative to an identified position 42 within the addressable media stream 34, based on receiving a message 38 that identifies the addressable media stream 34 by its media stream identifier 44, and that further includes the user identifier 52, and at least one identified user input 40 and the corresponding position 42, such that the user input 40 is identified relative to the corresponding identified position 42. The media clip generation circuit 30 also can identify one or more user inputs that are identified relative to a corresponding identified position 42 based on accessing the user response data file 46′ within the database 54, for example via a wide area network such as the Internet 26. The media clip generation circuit 30 illustrated in FIG. 1B can directly receive one or more messages that specify the user input 40 that is identified relative to the corresponding identified position 42 within the addressable media stream, illustrated by message 38b.

As illustrated in FIG. 3, the media clip generation circuit 30 can access the user response data file 46′ and parse the user inputs 40 in order to identify whether a given user input 40 demonstrates a favorable affinity by the corresponding identified user 52 toward a corresponding identified position 42. For example, the user inputs illustrated in FIG. 1B and/or FIG. 2 of a full screen command, a smiley face button pressed by a user, a volume increase command input by a user, and another full screen command demonstrate that the users have a favorable affinity toward the respective identified positions based on their greater interest in the content (illustrated by increasing a display size to full screen or increasing the volume), or by an explicit comment input by the user, for example in the form of a smiley face based on pressing a prescribed a function key on the keyboard 24 or a user remote. Each of these user inputs also can be assigned a corresponding weighting function or weighting value that identifies a relative affinity toward the identified position: for example, a smiley face input by a user 32 may demonstrate a greater affinity than a full screen command, and a full screen command may demonstrate a greater affinity than simply increasing the volume.

Other user inputs also can be identified with respect to identified positions of an addressable media stream, for example detecting a user comment input by the user at the corresponding position, etc. Additional details relating to associating user comments and other actions to identify positions of the addressable media stream are described in commonly-assigned, copending U.S. patent application Ser. No. 12/110,238, filed Apr. 25, 2008, entitled “Associating User Comments to Events Presented in a Media Stream”. In summary, the processor circuit 14 can collect a comment that is input by a user into a user device, based on identifying a time that the user generated the comment. The processor circuit 14 also can associate the comment input by the user with an identifiable addressable media stream and at an identified position within the addressable media stream that is coincident with the time that the user generated the comment relative to an event presented in the addressable media stream. The processor circuit 14 also can generate and output a media comment message that identifies the user, the comment generated by the user, the addressable media stream and the identified position within the addressable media stream coinciding with the time that the user generated the comment.

As illustrated in FIG. 3, the media clip generation circuit 30 can be configured for generating, from the determined affinity values for each of the user inputs 40, an affinity distribution 62 that measures the affinity values 64 relative to a position axis 66 (e.g., timeline) for the addressable media stream 34. As illustrated in FIG. 3, in the media clip generation circuit 30 can determine that the affinity distribution 62 includes three “peaks” 68 at the respective identified positions 42a, 42b, and 42c. Alternately, the affinity distribution 62 can be determined by another server (e.g., the data collection server 56), and stored as a distinct data structure 62′ in the database 54, where the stored data structure 62′ can be retrieved and interpreted by the media clip generation circuit 30. Hence, the media clip generation circuit 30 can determine that the identified positions 42a, 42b and 42c demonstrate the highest relative aggregate affinity values among the multiple users 32 having supplied to the inputs 40. The media clip generation circuit 30 can generate, for each identified position 42a, 42b, and 42c, a corresponding media clip 78 (e.g., 78a for position 42a, 78b for position 42b, and 78c for position 42c) based on the media clip generation circuit 30 selecting for each identified position 42a, 42b and 42c a corresponding start position 70 and a corresponding end position 72 from within the addressable media stream 34. Hence, each media clip 78 is defined by the media clip generation circuit 30 selecting a corresponding media clip start position 70 preceding the corresponding identified position (e.g., 42a, 42b, or 42c) and a corresponding media clip end position 72 that follows the corresponding identified position (e.g., 42a, 42b, or 42c). Consequently, the media clip generation circuit 30 can concatenate in step 74 the media clips 68 in order to create the summary media clip 60 of the addressable media stream.

Hence, the summary media clip 60 can be created automatically by the media clip generation circuit 30 from one or more dynamically-defined media clips 68 based on the media clip generation circuit 30 identifying one or more positions (e.g., 42a, 42b, or 42c) that identify the highest relative favorable affinity among one or more users based on determining the relative affinity demonstrated by the corresponding user input. Moreover, since the media clips 68 are defined based on determining the relative affinity 64 demonstrated by the user inputs 40, where user responses are evaluated relative to identified positions, a summary media clip 60 can be created for any addressable media stream without the necessity of analyzing or interpreting the actual content within the addressable media stream.

Moreover, the disclosed media clip generation circuit 30 can generate the summary media clip 60 for any number of users and known any number of user inputs 40, such that a single-user application can define a media clip 42 for each identified user input demonstrating a favorable affinity toward the corresponding identified position. Further, various filtering techniques and classification techniques can be used in applications utilizing multiple user inputs and/or multiple users based on the input type, or based on classification of the user desiring to view the summary media clip 60. Further, the data associated with the affinity distribution 62 and/or the defined media clips 68 can be stored by the media clip generation circuit 30 as a metadata files 62′, 76 within the database 54. For example, a first summary media clip metadata file (F1) 76a can be generated by the media clip generation circuit 30, where the first summary media clip metadata file (F1) 76 can define the summary media clip 60 to be created for a generic class of users; the media clip generation circuit 30 also can generate a second summary media clip metadata file (F2) 76b that defines a summary media clip for a first class of users (e.g., women), a third summary media clip metadata file (F3) 76c for another class of users (e.g., men), etc. Each summary media clip metadata file (e.g., 76a) can include, for each media clip 78, the corresponding media clip start position (e.g., “3:40” for media clip 78a) 70, and the corresponding media clip end position (e.g., “3:51” for media clip 78a) 72. Each summary media clip metadata file 76 also can include, for each media clip 78, the corresponding identified position 42: if a summary clip 60 is based on a sequence of media clips 78 that are not ordered sequentially (e.g., ordered based on popularity), the media clip generation circuit 30 can add to the summary media clip metadata file 76 a media clip sequence identifier that identifies the sequence of the media clips 78 within the summary media clip 60.

FIGS. 4A and 4B illustrate a method of creating a summary video stream, according to an example embodiment. The steps described in FIGS. 4A and 4B can be implemented as executable code stored on a computer readable medium (e.g., floppy disk, hard disk, ROM, EEPROM, nonvolatile RAM, CD-ROM, etc.) that are completed based on execution of the code by a processor circuit; the steps described herein also can be implemented as executable logic that is encoded in one or more tangible media for execution (e.g., programmable logic arrays or devices, field programmable gate arrays, programmable array logic, application specific integrated circuits, etc.).

Referring to FIG. 4A, the device interface circuit 12 of the apparatus 10 of FIG. 1A or the apparatus 50 of FIG. 2 can receive in step 80 a message 38 from the media player circuit 28: the message 38 can specify the media stream identifier 44 for an addressable media stream 34 that has been selected for presentation by the user 32 of the media player circuit 28; if the apparatus 10 or 50 is configured for receiving inputs from a plurality of users, or if in the case of the apparatus 50 the user 32 is located at a remote location and requires transmission of the message 38 via a local or wide area network 26, the message 38 also can include a user identifier 52 or some other alias that uniquely distinguishes the user 32 from other users 32. The device interface circuit 12 forwards the received message 38 to the media clip generation circuit 30, causing the media clip generation circuit 30 to associate the user 32 with the addressable media stream 34, for example based on creating the data structure 46 of FIG. 1B, or adding the user identifier 52 to an existing data structure 46′ as illustrated in FIG. 2.

Hence, the initial message 38 (e.g., 38a of FIG. 1B or 38c of FIG. 2) enables the media clip generation circuit 30 to identify the addressable media stream 34 (identifiable by the corresponding identifier 44) selected for presentation by the corresponding identified user 32 (identifiable by the user identifier 52 for remote users).

The media clip generation circuit 30 can receive in step 82, via its associated network interface circuit 22, a message (e.g., 38b of FIG. 1B or 38c of FIG. 2) from the media player circuit 28 that specifies a user input 40 that is input by the user 32 during presentation of the addressable media stream 34 to the user 32, where the user input 40 is identified relative to the corresponding identified position 42 within the addressable media stream 34. Hence, the message 38 received in step 82 enables the media clip generation circuit 30 to identify the user input 40 that is input (i.e., supplied) by the user relative to the corresponding identified position 42 within the addressable media stream 34. The media clip generation circuit 30 can store in step 84 a user input entry 48 or 48′ to the data structure 46 or 46′ illustrated in FIG. 1B or FIG. 2, respectively, in response to receiving the message in step 82, in order to record the user input 40 supplied by the user 32 relative to the corresponding identified position 42.

The media clip generation circuit 30 can be configured in step 86 to implement real-time affinity updates of the affinity distribution 62 stored in the data structure 62′ in response to each received message 38. Assuming real-time affinity updates are not implemented, the media clip generation circuit 30 can determine whether an end of presentation to the user is detected, for example based on receiving an ending message from the media player circuit 28, or determining from a media server 24 that a supply of streaming media of the addressable media stream 34 to the media player circuit 28 has been terminated. Assuming the end of the presentation is not detected in step 88, the media clip generation circuit 30 can continue to monitor for additional messages 38 from the media player circuit 28. Alternately, the media clip generation circuit 30 can be configured for operating asynchronously, where the media clip generation circuit 30 can continue generation of the summary media clip 60, as described below, either periodically or in response to prescribed detected conditions, for example upon receiving another message 38 specifying that the user has selected another addressable media stream for presentation.

The media clip generation circuit 30 initiates a determination of affinity values toward the identified positions 40 within the addressable media stream 34 in step 90, where the media clip generation circuit can parse the user inputs 40 that are stored in the data structure 46 or 46′, and assign to each detected user input a determined affinity value specifying whether the corresponding input demonstrates a favorable affinity by the user 32 toward the identified position 42 of the media stream 34. As described above, numerous techniques can be used for evaluating the affinity of a given user input 40, including a prescribed mapping operation of a prescribed input mapped to a corresponding prescribed affinity value; more complex systems also can be applied for determining the affinity values. Additional details related to determining affinity values are described in the commonly-assigned, copending U.S. patent application Ser. No. 12/110,238, which describes that the user inputs 40 can be interpreted as “socially relevant gestures” that indicate user preferences or opinions toward identifiable content assets, such as the identifiable positions 42 within the addressable media stream 34. Determining affinity values from user inputs also is described in commonly-assigned, copending U.S. patent application Ser. No. 11/947,298, filed Nov. 29, 2007, entitled “Socially Collaborative Filtering”.

If in step 92 a single user application is involved, for example as illustrated of FIG. 1A where a single user is supplying user inputs 40 during presentation of the addressable media stream 34, a simplified procedure for identifying positions 42 for use in generating a media clip can be implemented. In particular, the media clip generation circuit 30 can identify in step 94 that each position 42 having a favorable (i.e., positive) affinity value (e.g., the user pressing a “thumbs up” button, a smiley face button, or an “I like it” button) should be chosen as a selected position for generation of a media clip 78.

Referring to FIG. 4B for the single user application, following step 94 the media clip generation circuit 30 can define in step 106 the media clips 78 from the addressable media stream 34 based on the media clip generation circuit 30 selecting a media clip start position 70 and a media clip end position 72 for each selected position in step 94. The corresponding media clip start position 70 and/or the corresponding media clip end position 72 for a given selected position (e.g., 42a of FIG. 3) can be selected in step 106 based on a detected scene transition in the addressable media stream 34, and/or based on a prescribed time interval (e.g., 5 seconds). The corresponding media clip start position 70 and/or media clip end position 72 also can be dynamically determined by the media clip generation circuit 30 based on additional factors, including multiple identified positions 42 that are closely spaced together: in this case, three identified positions (e.g., A, B, C) 42 that are spaced five (5) seconds apart may result in “joining” the three identified positions into a single media clip 78 containing the three identified positions (e.g., A, B, C) and having the corresponding start position 70 that precedes the first identified position (e.g., A), and a the corresponding end position 72 following the third identified position (e.g., C). The start position 70 and end position 72 also can be dynamically selected to provide a longer-duration clip 78 for positions 42 determined as having higher relative affinity values, as opposed to a shorter-duration clip 78 for a less popular position.

The media clip generation circuit 30 can store in step 108 a metadata file 76 into the memory circuit 16 identifying the media clips 78, and create in step 110 the summary media clip 60 based on concatenating the selected media clips 78, for example based on a time sequence or ordered according to the most popular. Hence, a single user application as illustrated in FIG. 1A enables automatic generation of a summary media clip 60 based on detecting the user inputs that are supplied by the user 32 during presentation of the addressable media stream 34, eliminating the necessity of a user utilizing video editing software in order to manually create media clips.

As illustrated in FIG. 4B, the media clip generation circuit 30 also is effective for multiple user applications, illustrated in FIG. 2. For example, the media clip generation circuit 30 can be configured for sending a prompt to a user that is requesting a summary media clip 60 (or determining from determined user attributes) to determine whether the user requesting the summary media clip 60 prefers a generic based summary media clip or a class-based summary media clip that is specifically tailored for a specific user class. Assuming in step 96 that the media clip generation circuit 30 determines that a class-based summary media clip 60 is preferred that is specifically tailored for a specific class of user (e.g., a specific user demographic, etc.), the media clip generation circuit 30 can obtain in step 98 classification information (e.g., cohort information) from user attribute information that describes the destination user (e.g., from the database 54). Hence, the media clip generation circuit 30 can generate in step 100 an affinity distribution map 62 for the selected user class. If in step 96 there is no preference for a specific class of user, a generic affinity distribution map 62 can be generated in step 102 by the media clip generation circuit 30.

The media clip generation circuit 30 can analyze the relevant affinity distribution map 62 from step 100 or 102 and identify in step 104 a selected number of the selected positions 42 in the affinity distribution map 62 having the highest aggregate affinity values for the selected user class or generic class. Hence, the media clip generation circuit 30 can determine in step 104 the peaks 68 of the affinity distribution map 62, illustrated in FIG. 3. In response to identifying the “best” selected positions (e.g., 42a, 42b, and 42c of FIG. 3), the media clip generation circuit 30 can define in step 106 the media clips 78a, 78b, and 78c for the respective selected positions 78a, 78b, and 78c. As described previously, each media clip (e.g., 78a) is defined based on selecting, for the corresponding selected position (e.g., 42a), a corresponding media clip start position (e.g., “P1-A”) 70 within the addressable media stream 34 that precedes the identified position (e.g., “P1” 42a), and a corresponding media clip end position (e.g., “P1+B”) 72 within the addressable media stream 34 and that follows the identified position (e.g., “P1” 42a). The media clip generation circuit 30 can store in step 108 the corresponding metadata file 76 that defines each of the selected media clips 78 and specifies the concatenation sequence determined in step 110 for creation of the summary media clip 60.

According to example embodiments, a summary media clip 60 can be automatically generated based on identifying user inputs that are input by a user during presentation of an addressable media stream. The summary media clip can be generated without user intervention (i.e., without user manipulation of the actual addressable media stream). Moreover, the defining of one or more media clips for the summary media clip based on identified positions within the addressable media stream eliminates any necessity for evaluating the content of the addressable media stream. Moreover, the summary media clip 60 can be dynamically updated for different user classes as additional user inputs are aggregated to the affinity distribution 62. Consequently, the summary media clips for different user classes can change over time, ensuring that prior-created summary media clips do not become “stale” for users. The example embodiments also can be applied to multi-dimensional addressable media streams, for example in the case of a DVD that offers multiple endings for a story, the summary clip may be created that includes the most popular ending for the story.

Although the example embodiments described receiving user inputs from a media player circuit, the user inputs can be received from other user input devices that are distinct from the media player, for example a separate user computer, a user cell phone, etc., each of which can be registered as a user input device relative to the addressable media stream. In this example, the user input can be identified relative to an identified position within the addressable media stream based on receiving a message identifying the user input and the time instance that the user generated the user input, where the media clip generation circuit can identify the position of the addressable media stream that was presented to the user at the time the user generated the user input. Association of other user input devices are described in further detail in the copending U.S. patent application Ser. No. 12/110,238.

Although the defining of media clips is described as based on identifying user inputs demonstrating a favorable affinity in the form of a positive user input, the user inputs can be identified relative to the aggregation of all the user inputs, enabling “neutral” user inputs to be deemed as demonstrating the most favorable affinity by the user. Hence, in the absence of any positive user inputs (e.g., a volume increase, a “thumbs up” input or smiley face input), a relatively “neutral” user input (e.g., pressing an “Info.” button to obtain more information about the addressable media stream) can be deemed a favorable affinity as opposed to negative user inputs (e.g., a volume decrease or mute, a “thumbs down” input or frowny face input), where the negative user inputs are assigned a negative affinity weighting to exclude the associated positions causing negative user inputs.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
identifying, by a device, an addressable media stream selected for presentation by a user;
identifying, by the device, a user input that is input by the user during presentation of the addressable media stream to the user, the user input identified relative to an identified position within the addressable media stream;
defining by the device a media clip from the addressable media stream based on determining the user input demonstrates a favorable affinity by the user toward the identified position, the defining including the device selecting a media clip start position within the addressable media stream and that precedes the identified position, and the device selecting a media clip end position that follows the identified position; and
creating by the device a summary media clip of the addressable media stream that includes at least the media clip.

2. The method of claim 1, wherein the addressable media stream is any one of an audio stream or a video stream, the identifying of the user input based on at least one of:
receiving by the device a message from a media player circuit presenting the addressable media stream to the user, the message specifying the identified position within the addressable media stream and the corresponding user input; or
accessing by the device a data structure configured for storing a plurality of user inputs that have been supplied by at least the user during the presentation of the addressable media stream.

3. The method of claim 2, wherein the identifying of the user input includes at least one of receiving the message, or accessing the data structure, via an Internet Protocol (IP) network.

4. The method of claim 2, wherein:
the identifying of the user input includes detecting the user inputs that are input by the user during presentation of the addressable media stream and identified relative to respective identified positions within the addressable media stream;
the defining includes selectively defining, for each identified position, a corresponding media clip based on the corresponding user input demonstrating a corresponding favorable affinity by the user toward the corresponding identified position;
the creating including concatenating media clips defined by the device.

5. The method of claim 1, wherein:
the identifying of the user input includes detecting a plurality of user inputs that are input by the user during presentation of the addressable media stream and identified relative to respective identified positions within the addressable media stream;
the defining includes selectively defining, for each identified position, a corresponding media clip based on the corresponding user input demonstrating a corresponding favorable affinity by the user toward the corresponding identified position;
the creating including concatenating media clips defined by the device.

6. The method of claim 1, wherein the defining includes selecting the media clip start position based on at least one of a detected scene transition preceding the identified position, or based on a prescribed time interval preceding the identified position.

7. The method of claim 1, wherein:
the identifying of the user input includes identifying a plurality of user inputs that are input by a plurality of users during presentation of the addressable media stream to the respective users, each user input identified relative to a corresponding identified position within the addressable media stream;
the defining includes selectively defining a plurality of media clips based on a determined distribution of the favorable affinity by at least a selected group of the users from the respective user inputs.

8. The method of claim 7, wherein the selectively defining includes identifying the selected group of the users for generation of the summary media clip for a member of the selected group of the users.

9. The method of claim 1, further comprising the device aggregating a plurality of user inputs based on:
receiving a message from a media player circuit presenting the addressable media stream to the user, the message specifying an identifier for the addressable media stream, a user identifier for the user, at least one of the user inputs input by the user, and at least one corresponding identified position within the addressable media stream identifying an instance that the user input the corresponding at least one user input; and
storing the user identifier, the at least one user input, and the corresponding identified position from the received message into a data structure for the addressable media stream.

10. The method of claim 9, wherein:
the aggregating includes receiving a plurality of messages from a plurality of media player circuits presenting the addressable media stream to a respective plurality of users, each message specifying the identifier for the addressable media stream, the corresponding user identifier, at least one of the user inputs input by the corresponding user, and at least one corresponding identified position within the addressable media stream identifying an instance that the corresponding user input the corresponding at least one user input;
the storing including storing the user inputs from the users into the data structure for the addressable media stream according to respective identified positions, the data structure indexed according to at least one of the identified positions, the respective user inputs, or user identifiers.

11. An apparatus comprising:
a device interface circuit configured for detecting selection of an addressable media stream selected for presentation by a user, the device interface circuit further configured for detection of a user input that is input by the user; and
a processor circuit configured for:
identifying the addressable media stream selected for presentation by the user,
identifying that the user input is input by the user during presentation of the addressable media stream to the user, the user input identified relative to an identified position within the addressable media stream,
defining a media clip from the addressable media stream based on determining the user input demonstrates a favorable affinity by the user toward the identified position, the defining including selecting a media clip start position within the addressable media stream and that precedes the identified position, and selecting a media clip end position that follows the identified position, and
creating a summary media clip of the addressable media stream that includes at least the media clip.

12. The apparatus of claim 11, wherein the addressable media stream is any one of an audio stream or a video stream, the processor circuit configured for identifying the user input based on at least one of:
the device interface circuit receiving a message from a media player circuit presenting the addressable media stream to the user, the message specifying the identified position within the addressable media stream and the corresponding user input; or
the processor circuit accessing a data structure configured for storing a plurality of user inputs that have been supplied by at least the user during the presentation of the addressable media stream.

13. The apparatus of claim 12, wherein the device interface circuit is configured for receiving the message, or the processor circuit is configured for accessing the data structure via the device interface circuit, via an Internet Protocol (IP) network.

14. The apparatus of claim 12, wherein:
the processor circuit is configured for detecting the user inputs that are input by the user during presentation of the addressable media stream and identified relative to respective identified positions within the addressable media stream;
the processor circuit configured for selectively defining, for each identified position, a corresponding media clip based on the corresponding user input demonstrating a corresponding favorable affinity by the user toward the corresponding identified position;
the processor circuit configured for creating the summary media clip based on concatenating media clips defined by the processor circuit.

15. The apparatus of claim 11, wherein:
the processor circuit is configured for detecting a plurality of user inputs that are input by the user during presentation of the addressable media stream and identified relative to respective identified positions within the addressable media stream;
the processor circuit configured for selectively defining, for each identified position, a corresponding media clip based on the corresponding user input demonstrating a corresponding favorable affinity by the user toward the corresponding identified position;
the processor circuit configured for creating the summary media clip based on concatenating media clips defined by the processor circuit.

16. The apparatus of claim 11, wherein the processor circuit configured for defining the media clip based on selecting the media clip start position based on at least one of a detected scene transition preceding the identified position, or based on a prescribed time interval preceding the identified position.

17. The apparatus of claim 11, wherein:
the processor circuit configured for identifying a plurality of user inputs that are input by a plurality of users during presentation of the addressable media stream to the respective users, each user input identified relative to a corresponding identified position within the addressable media stream;
the processor circuit configured for selectively defining a plurality of media clips based on a determined distribution of the favorable affinity by at least a selected group of the users from the respective user inputs.

18. The apparatus of claim 17, wherein the processor circuit configured for identifying the selected group of the users for generation of the summary media clip for a member of the selected group of the users.

19. The apparatus of claim 11, wherein:
the processor circuit is configured for aggregating a plurality of user inputs based on the device interface circuit receiving a message from a media player circuit presenting the addressable media stream to the user, the message specifying an identifier for the addressable media stream, a user identifier for the user, at least one of the user inputs input by the user, and at least one corresponding identified position within the addressable media stream identifying an instance that the user input the corresponding at least one user input;
the processor circuit configured for storing the user identifier, the at least one user input, and the corresponding identified position from the received message into a data structure for the addressable media stream.

20. The apparatus of claim 19, wherein:
the device interface circuit is configured for receiving a plurality of messages from a plurality of media player circuits presenting the addressable media stream to a respective plurality of users, each message specifying the identifier for the addressable media stream, the corresponding user identifier, at least one of the user inputs input by the corresponding user, and at least one corresponding identified position within the addressable media stream identifying an instance that the corresponding user input the corresponding at least one user input;
the processor circuit configured for storing the user inputs from the users into the data structure for the addressable media stream according to respective identified positions, the data structure indexed by the processor circuit according to at least one of the identified positions, the respective user inputs, or user identifiers.

21. An apparatus comprising:
a device interface circuit configured for detecting selection of an addressable media stream selected for presentation by a user, the device interface circuit further configured for detection of a user input that is input by the user; and
means for identifying the addressable media stream selected for presentation by the user, the means for identifying further configured for:
identifying that the user input is input by the user during presentation of the addressable media stream to the user, the user input identified relative to an identified position within the addressable media stream,
defining a media clip from the addressable media stream based on determining the user input demonstrates a favorable affinity by the user toward the identified position, the defining including selecting a media clip start position within the addressable media stream and that precedes the identified position, and selecting a media clip end position that follows the identified position, and
creating a summary media clip of the addressable media stream that includes at least the media clip.

22. Logic encoded in one or more tangible media for execution and when executed operable for:
identifying, by a device, an addressable media stream selected for presentation by a user;
identifying, by the device, a user input that is input by the user during presentation of the addressable media stream to the user, the user input identified relative to an identified position within the addressable media stream;
defining by the device a media clip from the addressable media stream based on determining the user input demonstrates a favorable affinity by the user toward the identified position, the defining including the device selecting a media clip start position within the addressable media stream and that precedes the identified position, and the device selecting a media clip end position that follows the identified position; and
creating by the device a summary media clip of the addressable media stream that includes at least the media clip.
